(19) United States
(12) Patent Application Publication
(10) Pub. No.: US 2025/0215910 A1
(43) Pub. Date: Jul. 3, 2025

(54) IMPROVED RETENTION SYSTEM

(71) Applicant: APLIX, Le Cellier (FR)

(72) Inventor: Lilia ZEMNI, Le Cellier (FR)

(73) Assignee: APLIX, Le Cellier (FR)

(21) Appl. No.: 18/838,011

(22) PCT Filed: Feb. 16, 2023
(86) PCT No.: PCT/FR2023/050205

§ 371 Date: Aug. 13, 2024

(30) Foreign Application Priority Data
Feb. 17, 2022 (FR) FR2201414

(51) Int. Cl. F16B 5/07; F16B 11/00

(52) U.S. Cl. CPC F16B 5/07; F16B 11/006

(57) ABSTRACT

A retaining device including: a base, including a woven material; a plurality of retaining elements, the retaining elements each including a rod and a head, the rod extending from an upper face of the base, and the head being formed at a free end of the rod opposite the upper face of the base, the rods of the retaining elements being intertwined into the woven material of the base, wherein a portion of each of the rods extending from the base is at least partially coated with resin.

### TECHNICAL FIELD

The present invention relates to an improved retaining device, particularly a hook-and-loop retaining device, and an improved retaining assembly, particularly a hook-and-loop retaining assembly.

### PRIOR ART

Hook-and-loop type systems are commonly used for many applications. Among the self-gripping systems, loop-hook or male-female type systems, and hook-hook, mushroom-mushroom or male-male type systems.

Male-male type systems are designed to create a connection between two identical systems, the retaining elements then typically being of mushroom type, so as to engage with each other. The assembly of such elements is simplified to the extent that the elements can be pre-positioned before engaging them. Such elements also provide a feeling of engagement for the user, which thus allows to ensure that the engagement is carried out correctly.

Furthermore, such closing systems provide high mechanical performance in terms of holding in position, although with a reduced opening-closing cycle compared to hook-loop type systems.

A recurring problem for the production of such retaining elements is to propose systems having interesting mechanical properties while meeting criteria in terms of industrialization and cost.

The present invention thus aims at overcoming at least partially these problems.

### DISCLOSURE OF THE INVENTION

For this purpose, the present disclosure relates to a retaining device comprising:
a base, comprising a woven material
a plurality of retaining elements, said retaining elements each comprising a rod and a head,
   the rod extending from an upper face of the base, and the head being formed at a free end of the rod opposite the upper face of the base,
   the rods of the retaining elements extending at least partly in the woven material of the base, in particular the rods of the retaining elements being intertwined into the woven material of the base,
   characterized in that a portion of each of the rods extending from the base is at least partially coated with resin.

According to one example, at least 7% of the height of each rod is coated with resin, in certain cases at least 10% of the height of each rod is coated with resin, the height being measured in a direction perpendicular to the upper face of the base.

According to one example, at least 7% of the height of each rod, which height extends from an upper face of the base, is coated with resin, in certain cases at least 10% of the height of each rod is coated with resin, the height being measured in a direction perpendicular to the upper face of the base.

According to one example, less than 95% of the height of each rod is coated with resin, or else less than 90% of the height of each rod is coated with resin, in certain cases less than 85% of the height of each rod is coated with resin, for example less than 80% of the height of each rod is coated with resin, or else less than 70% of the height of each rod is coated with resin, in other cases less than 50% of the height of each rod is coated with resin, in yet other cases less than 40% of the height of each rod is coated with resin, or else less 35% of the height of each rod is coated with resin, in yet another case less than 30% of the height of each rod is coated with resin or else less than 25% of the height of each rod is coated with resin, the height being measured in a direction perpendicular to the upper face of the base, and from the upper face of the base. In other words, the height of the rod in the base is not taken into consideration here to determine the height of the rod of the retaining element of the retaining device according to the invention.

According to one example, each retaining element has a height greater than or equal to 0.5 mm, and the resin coating covers at least 0.1 mm of the height of each rod. According to one example, each retaining element has a height greater than or equal to 0.5 mm, and the resin coating covers at least 0.1 mm of the height of each rod. According to one example, each retaining element has a height greater than or equal to 1 mm, and the resin coating covers at least 0.15 mm of the height of each rod. According to one example, each retaining element has a height greater than or equal to 1.5 mm, and the resin coating covers at least 0.2 mm of the height of each rod.

According to one example, each retaining element has a height less than or equal to 5 mm, and the resin coating covers at least 0.1 mm of the height of each rod.

According to one example, the heads of the retaining elements have the shape of a portion of a sphere, extending from the free end of the rod.

According to one example, the rod has a circular section.

According to one example, the rod of the retaining elements can be formed so as to define a flange extending radially around the free end of the rod. This flange allows, for example, to engage similar retaining elements. The flange may have a proximal portion arranged on the side of the base and a distal portion arranged opposite the proximal portion and defining the free end of the retaining element. According to one example, the width, in side view of the proximal portion, is greater than the width of the distal portion of the flange. In some cases, the flange has the general shape of a cone or a volcano. According to one example, in a lateral view of the retaining device along a plane perpendicular to the upper face of the base, the projection of the visible part of the flange in this plane perpendicular to the base has variable heights varying between a minimum value comprised between 0% and 90% of the height of the flange measured as a maximum value, and a maximum value comprised between 95% and 100% of the height of the flange measured as a maximum value, in particular a minimum comprised between 2% and 90% of the height of the flange measured as a maximum value.

According to one example, the resin coating is produced with an epoxy resin or a polyurethane resin, in particular an aliphatic polyurethane resin, more particularly with a polyester-based aliphatic polyurethane resin.

According to one example, the resin is arranged on the upper face of the base and/or on the lower face of the base and/or inside the base.

According to one example, the resin coating is produced with an aqueous or solvent-based resin comprising for example a glue, which glue and/or which resin having a viscosity less than or equal to 1500 mPa·s, in particular less than or equal to 1000 mPa·s, in particular less than or equal to 500 mPa·s, more particularly less than or equal to 200 mPa·s, and/or in certain cases greater than or equal to 25 mPa·s, more particularly greater than or equal to 50 mPa·s.

According to one example, a lower face of the base, opposite the upper face of the base, is covered with an adhesive, in certain cases the adhesive has a normal separation force (in a direction perpendicular to the base) greater than 100 kPa according to standard ASTM D-897.

According to one embodiment, the retaining device comprises an amount of resin mainly arranged in the base.

According to one embodiment, the amount of resin coating at least a portion of each of the rods extending from the base is less than the amount of resin arranged in the base, in particular is less than the amount of resin of the rest of the retaining device.

According to one example, the base is formed of synthetic monofilament and/or multifilament wires which are woven.

According to one example, said synthetic wires are synthetic thermoplastic wires which include or which are based on, without limitation, polyolefins, for example polyethylene (PE), high density polyethylene (HDPE), polypropylene (PP), polybutylene and the like; polyamide (PA), for example aliphatic polyamides such as polyamide 6, polyamide 6.6, polyamide 10, polyamide 11, polyamide 12 and the like or else aromatic polyamides such as polyarylamides (PAA) or polyphthalamides (PPA); polyesters, for example polyethylene terephthalates (PET), polybutylenes terephthalates (PBT), polylactic acids, poly(phenylene sulfide) (PPS), Polysulfones, Polyacetals including polyoxymethylenes (POM), polycarbonates (PC), polystyrenes and the like, and mixtures and co-polymers thereof.

According to one example, the base wires are made of polyamide and the retaining elements are made of polypropylene.

According to one example, the retaining elements are formed from monofilament or multifilament wire, which may in particular include or be based on, without limitation, polyolefins, for example polyethylene (PE), high density polyethylene (HDPE), polypropylene (PP), polybutylene and the like; polyamide (PA), for example aliphatic polyamides such as polyamide 6, polyamide 6.6, polyamide 10, polyamide 11, polyamide 12 and the like or else aromatic polyamides such as polyarylamides (PAA) or polyphthalamides (PPA); polyesters, for example polyethylene terephthalates (PET), polybutylenes terephthalates (PBT), polylactic acids, poly(phenylene sulfide) (PPS), Polysulfones, Polyacetals including polyoxymethylenes (POM), polycarbonates (PC), polystyrenes and the like, and mixtures and co-polymers thereof.

According to one example, the upper face of the base has a density of retaining elements greater than or equal to 15 retaining elements per cm², in particular greater than or equal to 20 cm², in particular greater than or equal to 30 retaining elements per cm², in particular greater than or equal to 38 retaining elements per cm². Thus, the density of retaining elements is sufficiently high to allow easy cooperation with other “male” type retaining elements to produce a “male-male” type closure.

According to one example, the upper face of the base has a density of retaining elements less than or equal to 100 retaining elements per cm², or less than or equal to 80 retaining elements per cm² or less than or equal to 60 retaining elements per cm² or less than or equal to 50 retaining elements per cm² or else less than or equal to 45 retaining elements per cm² or else less than or equal to 40 retaining elements per cm². Thus, the density of retaining elements is sufficiently low to allow easy cooperation with other “male” type retaining elements to achieve a “Male-Male” type closure.

According to one example, the base is composed of warp threads and weft threads intertwined in a repeatable pattern, and in which the rods of the retaining elements are intertwined in said warp and weft threads, so that each retaining element rod is intertwined in the base so as to at least partially surround a warp thread or a weft thread of the base.

According to one example, in the weft direction, the retaining device successively comprises pairs of rods connected together by a junction portion intertwined in the base, which rods and junction portion having a general V or W shape.

According to one example, the base comprises a monofilament weft thread and a warp thread which is monofilament.

According to one example, the material constituting the wires of the base has a melting temperature which is at least 30° C. higher than the melting temperature of the material constituting the retaining element, preferably which is at least 50° C. higher, more preferably which is at least 70° C. higher.

The weight of the resin is comprised between 25 and 300 g/m², in particular between 50 and 200 g/m².

The apparent volumetric mass of the resin is greater than 200 Kg/m³, in particular greater than 500 Kg/m³ and/or less than 1300 Kg/m³, in particular less than 1200 Kg/m³.

According to one example, the ratio of the section of the rods of the retaining elements to the section of one of the wires of the base is comprised between 0.5 and 20, preferably between 1 and 5. According to one example, the ratio of the section of the rods of the retaining elements to the section of the two wires of the base is comprised between 0.5 and 20, preferably between 1 and 5.

According to one example, in a portion of the rod extending from the base and coated at least partially with resin, according to an MD and/or CD view, the assembly formed by the resin and the rod has a dimension according to an axis perpendicular to the base which is 1.2 times lower than the height of the rod taken in isolation (that is to say the rod not coated with resin), the height of the rod being measured along an axis perpendicular to the base, in particular 1.3 times smaller than the dimension of the rod alone, in particular 2 times smaller than the dimension of the rod alone, for example 1.5 times smaller than the dimension of the rod alone, or else 3 times smaller than the dimension of the rod alone, or in other cases 4 times smaller than the dimension of the rod alone.

According to one example, in a portion of the rod extending from the base and coated at least partially with resin, according to an MD and/or CD view, the assembly formed by the resin and the rod has a dimension according to an axis perpendicular to the axis of the rod which is less than 4 times the dimension of the rod alone, in particular less than 3 times the dimension of the rod alone, in particular less than 2 times the dimension of the rod alone, for example less than 1.5 times the dimension of the rod alone, or else less than 1.3 times the dimension of the rod alone, or in other cases less than 1.2 times the dimension of the rod alone.

The retaining device comprising resin at least partially coating a portion of each of the rods, the device, between two adjacent rods in an MD and/or CD view, being devoid of resin or comprising resin, the height of resin (from the base) is less than the height of the resin (from the base) at least partially coating a portion of each of the rods, in particular is at least 15% less, in particular 30% less.

In particular, the ratio of the height of the resin between two adjacent rods and the height of the resin at least partially coating a portion of each of the rods is less than 0.95, in particular less than 0.85, in particular less than 0.7, in certain cases less than 0.6, preferably less than 0.5, 0.4, 0.3, 0.2, 0.1 or else equal to 0.

The resin at least partially coating the rod is remote from the head of the retaining elements.

The different examples presented can be taken individually or in combination.

### BRIEF DESCRIPTION OF THE DRAWINGS

The invention and its advantages will be better understood upon reading the detailed description given below of different embodiments of the invention given by way of non-limiting examples.

FIG. 1 is an overview of a device according to one aspect of the invention.

FIG. 2 is another view of a device according to one aspect of the invention.

FIG. 3 is a sectional view of a device according to one aspect of the invention.

FIG. 4 is a view illustrating a step of producing a device according to one aspect of the invention.

FIG. 5 is another view schematically showing a step of producing a device according to one aspect of the invention.

FIG. 6 is a detailed sectional view illustrating an example of structure of a device according to one aspect of the invention.

FIG. 7 is a detailed sectional view illustrating another example of structure of a device according to one aspect of the invention.

FIG. 8 is a view illustrating a step of producing a device according to one aspect of the invention.

In all the figures, common elements are identified by identical numerical references.

### DESCRIPTION OF EMBODIMENTS

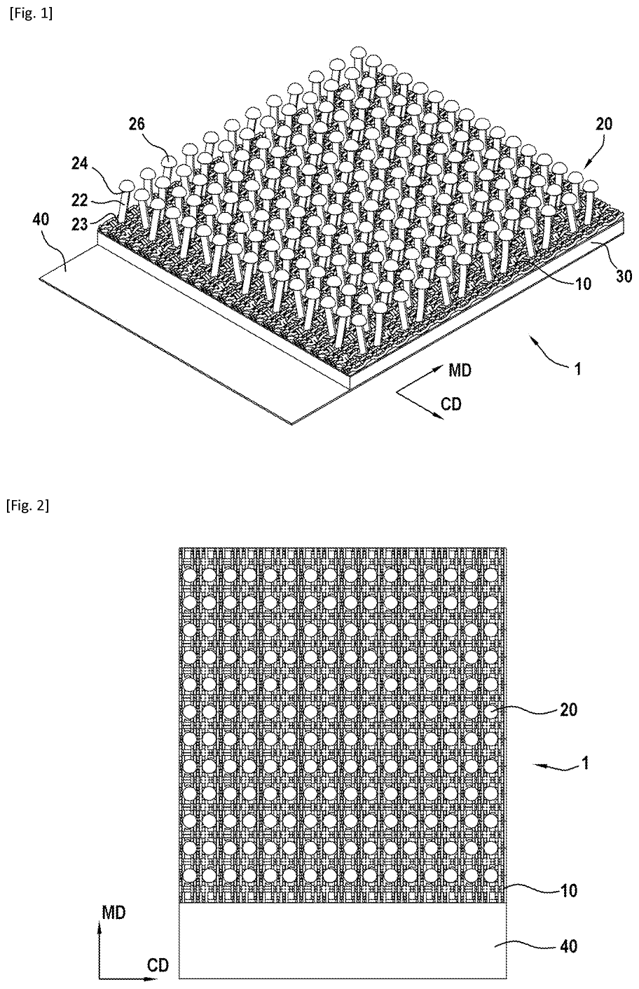

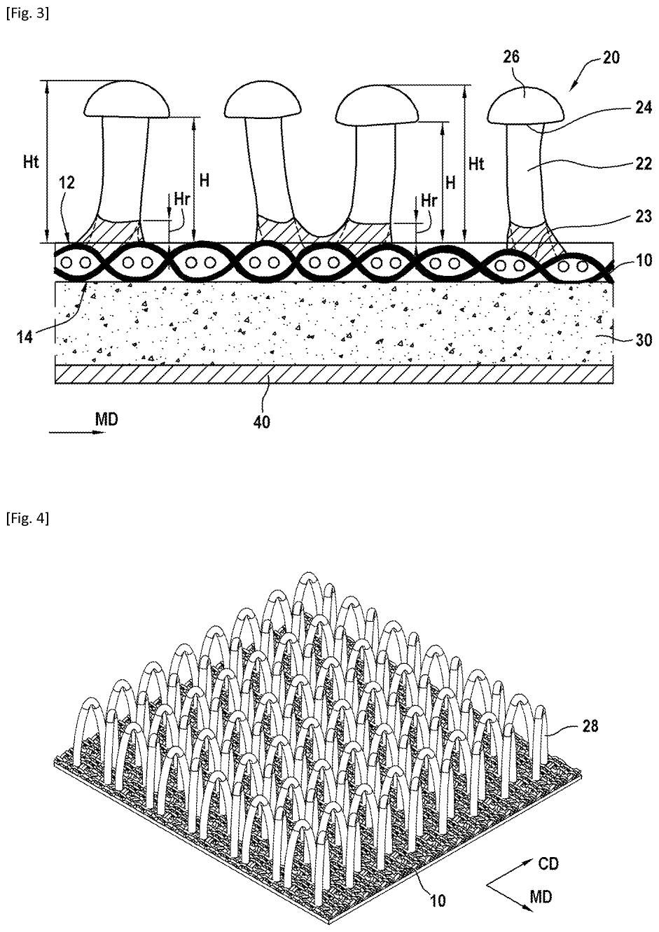

FIG. 1 shows a perspective view of an example of a device according to one aspect of the invention. FIG. 2 is a top view of FIG. 1. FIG. 3 is a detailed and sectional view of FIG. 1.

The figures show a retaining device 1 comprising a base 10 from which a plurality of retaining elements 20 extend.

The base 10 is in particular composed of a woven material. The base 10 is typically composed of warp threads and weft threads intertwined in a repeatable pattern. The warp threads and the weft threads typically have a diameter less than or equal to 0.5 mm, typically less than or equal to 0.3 mm, or for example less than or equal to 0.25 mm, or less than or equal to 0.2 mm.

The base 10 is typically composed of synthetic monofilament and/or multifilament wires which are woven, for example polyamide wires. The synthetic wires may for example be synthetic thermoplastic wires which include or are based on, without limitation, polyolefins, for example polyethylene (PE), high density polyethylene (HDPE), polypropylene (PP), polybutylene and the like; polyamide (PA), for example aliphatic polyamides such as polyamide 6, polyamide 6.6, polyamide 10, polyamide 11, polyamide 12 and the like or else aromatic polyamides such as polyarylamides (PAA) or polyphthalamides (PPA); polyesters, for example polyethylene terephthalates (PET), polybutylenes terephthalates (PBT), polylactic acids, poly(phenylene sulfide) (PPS), Polysulfones, Polyacetals including polyoxymethylenes (POM), polycarbonates (PC), polystyrenes and the like, and mixtures and co-polymers thereof.

The material constituting the wires of the base may for example have a melting temperature which is at least 30° C. higher than the melting temperature of the material constituting the retaining element, or which is at least 50° C. higher, or which is for example at least 70° C. higher, or for example at least 100° C. higher, or else at least 110° C. higher. Such a difference in the melting temperatures thus allows to form the heads of the retaining elements 20 by heating and deformation of the rod without impacting the material forming the base 10.

An upper face 12 of the base 10 and a lower face 14 of the base are defined arbitrarily, these designations being arbitrary and for illustration purposes only. Here it is considered for illustration purposes that the base 10 is positioned flat, and the upper face 12 of the base 10 is flat or substantially flat and defines a horizontal plane. Likewise, here it is also considered for illustration purposes that the lower face 14 of the base 10 is flat or substantially flat and defines a horizontal plane.

The retaining elements 20 are formed by hooks which are commonly referred to as “mushroom”. Such retaining elements 20 have a rod 22 extending from the upper face 12 of the base 10. Thus, for the rod 22 a proximal end 23 at the upper face 12 of the base 10, and a distal end 24 or opposite free end 24 are defined. A head 26 is formed on the free end 24 of the rod 22. The head has a shape adapted so that two identical retaining devices 1 can engage on each other by engaging their respective retaining elements 20 or adapt with another equivalent retaining device, namely not identical, and comprising a base and rods, each rod being surmounted by a head. This type of closure is generally called “male-male closure” or “self-gripping fastener”.

The rod 22 of the retaining elements is typically formed so as to define a flange extending radially around the free end 24 of the rod 22. This flange allows similar retaining elements 20 to be engaged. The flange has a proximal portion arranged on the side of the base 10 and a distal portion arranged opposite the proximal portion and defining the free end of the retaining element 20. According to one example, the width, in a side view of the proximal portion is greater than the width of the distal portion of the flange. In some cases, the flange has the general shape of a cone or a volcano. According to one example, in a lateral view of the retaining device along a plane perpendicular to the upper face 12 of the base 10, the projection of the visible part of the flange in this plane perpendicular to the base has variable heights varying between a minimum comprised between 0% and 90% of the height of the flange measured as a maximum value, and a maximum comprised between 95% and 100% of the height of the flange measured as a maximum value, in particular a minimum comprised between 2% and 90% of the height of the flange measured as a maximum value.

The rod 22 can for example have a circular, oval, polygonal section or more generally any suitable shape. In particular, it is possible to produce a rod 22 having a cross-shaped or “plus”-shaped section. Such a cross-shaped section typically has four ribs distributed regularly around a central axis of the rod 22, and extending radially around this central axis of the rod 22. More generally, the rod 22 can for example have an oval or square or rectangular section or in the general shape of a star with X regularly distributed arms, X being comprised between 3 and 10, each arm having a proximal end and a distal end, the proximal ends of each of the arms being contiguous and the distal ends of the arms are all spaced from each other at the same angle.

The head 26 of the retaining elements 20 is typically produced by cutting and deforming the free end 24 of the rod 22. The shape of the head 26 of the retaining elements 20 thus typically depends on the shape of the rod 22.

Thus, in the case of a rod 22 having a circular section, the head 22 will then typically have the shape of a portion of a sphere. In the case of a type 22 section having a cross shape, the head 22 will then typically have a shape defining four lobes. More generally, a section 22 of polygonal shape will typically be associated with a head 26 having a plurality of lobes, the number of lobes possibly depending on the shape of the polygon and being for example comprised between 2 and 10.

The retaining elements 20 typically have a total height Ht typically greater than or equal to 0.5 mm, or 0.7 mm, or 0.8 mm, or 1 mm, or 1.5 mm, or 1.8 mm, and typically less than or equal to 5 mm, or 3.5 mm, or 3 mm, or 2.5 mm. The total height is measured in a direction perpendicular to the upper face 12 of the base 10, from the proximal end 23 of the rod 22 to the opposite end of the head 26.

The retaining device 1 typically has a total height greater than or equal to 1.3 mm, or 1.5 mm, or 1.6 mm, or 1.8 mm, or 2.3 mm, or 2.6 mm and typically less than or equal to 5.8 mm, or 4.3 mm, or 3.8 mm, or 3.3 mm. The total height of the retaining device 1 is measured in a direction perpendicular to the upper face 12 of the base 10, from the lower face 14 of the base 10 to the distal end of the head 26.

The retaining device 1 typically has a density of retaining elements 20 greater than or equal to 15 retaining elements per cm², or greater than or equal to 20 retaining elements per cm², or greater than or equal to 25 retaining elements per cm² or greater than or equal to 30 retaining elements per cm², and typically less than or equal to 100 retaining elements per cm², or less than or equal to 80 retaining elements per cm² or less than or equal to 60 retaining elements per cm² or less than or equal to 45 retaining elements per cm². With such a density of retaining elements, the retaining elements of the retaining device are sufficiently dense to cooperate with other retaining elements of the same category of another retaining device, namely of the “male” type, and sufficiently sparse (not dense) to allow their extraction with the other retaining elements of the same category, namely “male” type.

The retaining elements 20 are typically formed by a cord of material, for example polypropylene, which is intertwined into the weft threads and the warp threads of the base 10. FIGS. 4, 5, 6, 7 and 8 thus schematically illustrate the production of the retaining elements 20.

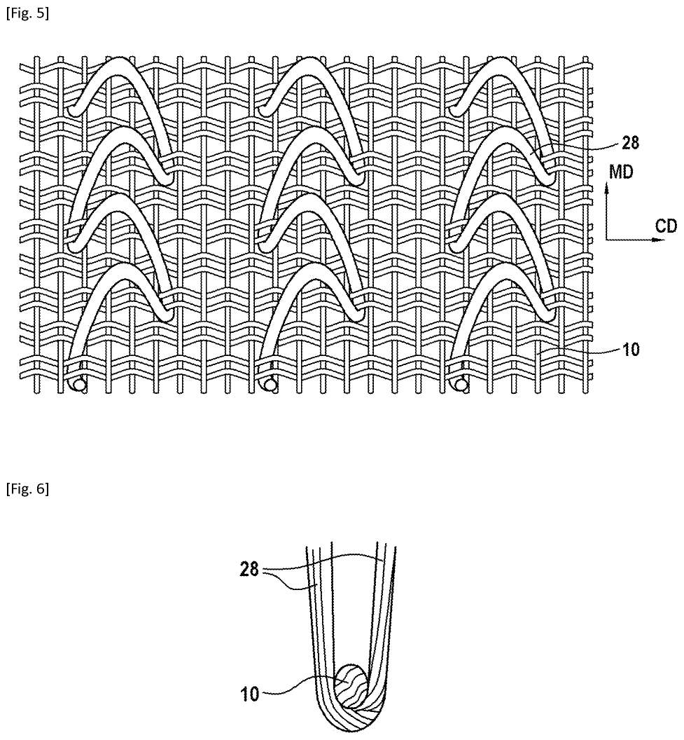

FIGS. 4 and 5 show a view of the base 10 in which cords of material 28 are intertwined. These cords of material 28 are here represented with a circular section; it is understood, however, that this example is not limiting.

The cords of material 28 are here intertwined in the weft and warp threads of the base 10 so as to form loops at least partially surrounding the weft threads and/or the warp threads. The cords 28 form arches which extend above the upper face 12 of the base 10 between two loops around weft threads or warp threads, as seen in particular in FIGS. 4 and 5. The warp threads define a warp direction MD (or else machine direction), and the weft threads define a weft direction CD (or else transverse direction, perpendicular to the machine direction).

The cords of material 28 can be intertwined in different patterns in the warp threads and the weft threads forming the base 10.

In the example of FIGS. 1 and 2, in the weft direction, 2 weft threads extend between two adjacent retaining elements, and, in the warp direction, an alternation of 6 warp threads extend between two adjacent retaining elements then 4 warp threads extend between one of the adjacent retaining elements and another retaining element adjacent to the latter.

According to an example of FIG. 5, the warp threads (or commonly also called background threads) extend in the vertical direction of FIG. 5 defining the warp direction MD while the weft threads extend perpendicular to the warp threads, in the horizontal direction of FIG. 5, defining the weft direction CD. According to the example shown in FIG. 5, 2 weft threads extend between two adjacent retaining elements and 4 warp threads extend between two adjacent retaining elements, without an alternation of different numbers of warp threads between the retaining elements here.

An arrangement of different warp threads and weft threads could be used, for example between 1 and 15 warp threads between two adjacent retaining elements and between 1 and 10 weft threads between two adjacent retaining elements with or without an alternation of the number of threads, that is to say by varying the number of warp threads between two retaining elements and/or by varying or not the number of weft threads between two retaining elements. According to another example, an arrangement of different warp threads and weft threads could be used, for example between 2 and 8 warp threads between two adjacent retaining elements and between 1 and 4 weft threads between two adjacent retaining elements with or without an alternation of the number of threads, that is to say by varying the number of warp threads between two retaining elements and/or by varying or not the number of weft threads between two retaining elements.

According to one example, the retaining elements of the device according to the invention are inclined relative to a normal axis (in a direction perpendicular to the upper face or to the lower face of the base 10). In particular, the inclination is comprised between 1° and 30° between a normal axis perpendicular to the upper face of the base 10 passing through the foot of the retaining element and a straight line passing through said foot of the retaining element and tangent to the distal end of the rod, in particular, the inclination is comprised between 2° and 15°.

According to one example, the cords of material 28 have a section that can be contained in a circle having a diameter equal to 1 mm, or equal to 0.8 mm, or equal to 0.7 mm, or equal to 0.6 mm, or equal to 0.5 mm.

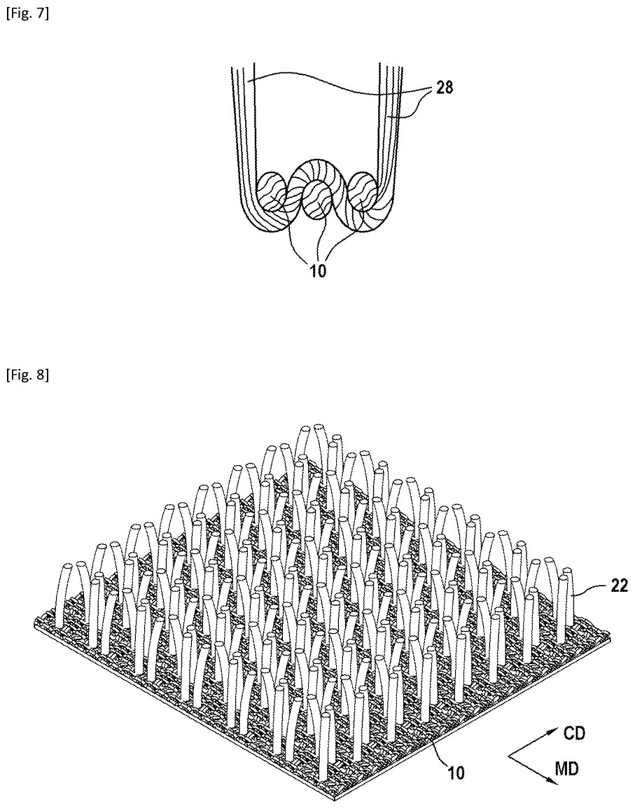

FIG. 6 and FIG. 7 show two embodiments for interweaving the cords of material 28 in the weft threads and the warp threads forming the base 10.

In the example shown schematically in FIG. 6, the cords of material 28 form a loop around one or more weft threads and/or one or more warp threads. Each loop of a cord of material 28 therefore has a point of attachment with the base 10. This configuration is called a V-shaped structure.

In the example shown schematically in FIG. 7, the cords of material 28 make a loop around at least 3 weft threads and/or warp threads of the base 10. Each loop of a cord of material 28 therefore has at least two fixing points with the base 10. This configuration is called a W-shaped structure.

These two examples of embodiment are not limiting, the connection between the cords of material 28 and the base 10 can be made according to any suitable pattern.

The base 10 is then typically coated with a resin, for example by coating and drying or by extrusion and cooling. More precisely, the lower face 14 of the base 10 is typically coated with an aqueous or solvent-based resin comprising in particular an aqueous glue. The resin is typically applied to the lower face 14 of the base 10, and thus fills the gaps between the warp threads and the weft threads forming the base 10, and passes through the thickness of the base 10 until it surrounds at least partially the rods 22 of the retaining elements 20, in particular the rods 22 extending outside the base 10. The aqueous or solvent resin used forming, for example a glue, is liquid due to its viscosity, which is typically less or equal to 1500 mPa·s, in particular less than or equal to 1000 mPa·s, in particular less than or equal to 500 mPa·s, or less than or equal to 300 mPa·s, or less than or equal to 200 mPa·s, or less or equal to 150 mPa·s, or less than or equal to 100 mPa·s, the viscosity being measured at a temperature of 25° C. with an LVT viscometer marketed under the brand “Brookfield”. Aqueous glue means a glue having a water content greater than 50% by mass of the liquid part of its composition before drying. The coating is typically carried out with an epoxy resin or a polyurethane resin, in particular an aliphatic polyurethane resin, more particularly a polyester-based aliphatic polyurethane resin. The coating thus typically forms a film with a thickness comprised between 1% and 50%, or between 1% and 25%, in particular between 1% and 15%, or between 10% and 40%, in particular between 20% and 40%, of the maximum dimension of the section of the cords of material 28 forming the rods 22, typically of the diameter of the section of the cords of material 28 forming the rods 22. In the case where the base 10 is formed of a woven material, therefore a coating of the wires composing the base and a coating of the rods 22 are carried out. Such a coating is distinct from a deposition of material which would form a thick layer on the upper face 12 of the base 10 and would thus greatly increase the thickness of the base 10, in particular by creating a significant continuous extra thickness between the different retaining elements.

The glue is typically associated with a crosslinking agent and/or a thickening agent and/or an anti-foaming agent together forming the resin.

More precisely, the resin covers a portion of the rod of the retaining elements 20 extending from the proximal end 23 of the rod 22.

Depending on the shape of the rod 22, the rod 22 can be at least partially covered with resin over part of the height H of the rod 22, the height of the rod 22 being measured from its proximal end 23, that is to say from the upper face 12 of the base 10 which is here considered flat, and in a direction perpendicular to the upper face 12 of the base 10. According to one example, the resin extends over at least 5% of the height of the rod 22, or over at least 10% of the height of the rod 22, or more precisely over at least 15% of the height of the rod 22, or else over at least 20% or 25% of the height of the rod 22. According to one example, the resin extends over at most 95% of the height of the rod 22, or over at most 90% of the height of the rod 22, or more precisely over at most 85% of the height of the rod 22, or else over at most 80% or 75% of the height of the rod 22. The height of the rod 22 covered at least partially with resin is designated by Hr. According to one example, each retaining element 20 has a height greater than or equal to 0.5 mm, and the resin coating covers at least 0.1 mm of the height of each rod. According to one example, each retaining element 20 has a height greater than or equal to 0.5 mm, and the resin coating covers at least 0.1 mm of the height of each rod. According to one example, each retaining element 20 has a height greater than or equal to 1 mm, and the resin coating covers at least 0.15 mm of the height of each rod. According to one example, each retaining element 20 has a height greater than or equal to 1.5 mm, and the resin coating covers at least 0.2 mm of the height of each rod. According to one example, each retaining element has a height less than or equal to 5 mm, and the resin coating covers at least 0.1 mm of the height of each rod.

The resin can extend over all or part of the external periphery of the rod 22 over the considered height. Considering a portion of the rod 22 comprised between the proximal end 23 and the height Hr, all or part of the external periphery of this portion of the rod 22 is then covered with resin. According to one example, at least 30% of the external periphery of this portion of the rod 22 is covered with resin, or more precisely at least 35%, 40%, 50%, 60%, 70%, 80% or 90% of the external periphery of this portion of the rod 22 is covered with resin.

The surface enveloped by the resin will in particular depend on the shape of the rod 22. It is understood in fact that the irregularities and the ridges on the external periphery of the rod 22 will promote a non-uniform distribution of the resin.

The base of each of the rods 22 of the retaining elements 20 is thus at least partially enveloped or coated with resin. This at least partial coating of the base of the rods 22 with resin thus stiffens the retaining elements and improves the cohesion of the whole. Thus, when the retaining elements 20 are engaged with similar or identical retaining elements, which improves the mechanical strength of the retaining elements, improves the stability of the product, and also the number of engagement and disengagement cycles that can be carried out.

The cords of material 28 are then cut so as to separate each arch into two rods, which thus form the rods 22 of the retaining elements 20. This operation is typically carried out using a cutting tool calibrated to cut the arches formed by the cords of material 28 at a predetermined height relative to the base 10. It is commonly referred to as a shaving operation.

The free ends of the rods 22 are then subjected to a forming operation to produce the head 26 of the retaining elements 20. This shaping operation comprises, for example, heating and deformation of the free ends of the rods 22 to obtain the desired shape for the heads 26 of the retaining elements 20. As indicated previously, the shape of the head of the retaining elements typically depends on the shape of the rod 22. In the case of heads 26 having the shape of a portion of a sphere, this step can for example be designated as a rounding operation.

The base 10 is typically coupled to an adhesive secured to the lower face 14 of the base 10. The adhesive typically comprises a layer of foam 30 secured to the lower face 14 of the base 10, and an adhesive tape 40 secured to the layer of foam 30, so that the layer of foam 30 is positioned between the lower face 14 of the base 10 and the adhesive tape 40. The adhesive has for example a normal separation force (in a direction perpendicular to the base 10) greater than 100 kPa according to standard ASTM D-897.

The foam layer 30 is typically composed of an acrylic foam with a minimum thickness which may be equal to 0.10 mm, 0.20 mm or 0.30 mm, and a maximum thickness which may be equal to 3 mm, 2 mm, 1 mm or 0.5 mm. The adhesive tape 40 is typically a pressure sensitive adhesive.

The adhesive tape 40 and the foam layer 30 are typically secured to each other, this assembly then being secured to the lower face 14 of the base 10 for example by means of an acrylic coating.

The retaining device 1 as proposed can be combined with a similar or identical retaining device.

The present disclosure thus relates to an assembly comprising a first retaining device according to any one of the embodiments described above, and a second retaining device comprising a base, a plurality of retaining elements each comprising a rod and a head, the rod extending from an upper face of the base, and the head being formed at a free end of the rod opposite the upper face of the base. Alternatively, the second retaining device can also be a retaining device according to any of the embodiments described above, identical to or distinct from the first retaining device.

The first and second retaining devices can then be associated by engagement of their respective retaining elements. This type of closure is generally called “male-male closure” or “self-gripping fastener”. The first and second retaining devices are typically positioned face to face, with their retaining elements thus facing each other. Pressure is then exerted so as to bring the retaining devices together, typically in a direction perpendicular to the base of the retaining devices, so that the heads of the first and second retaining devices engage. More precisely, considering by way of example that the first retaining device is held fixed and that the second retaining device is pressed on the first retaining device, the heads of the retaining elements of the second retaining device will extend beyond a plane defined by the heads of the retaining elements of the first retaining device, and thus pass beyond the heads of the retaining elements of the first retaining device. Thus, the heads of the retaining devices will engage via portions projecting from the rods, and oppose a separation of the retaining devices.

The normal separation force (in a direction perpendicular to the base 10) of the two retaining devices is for example at least greater than 10 N/cm² and/or has a normal engagement force (in a direction perpendicular to the base 10) of the two devices greater than 5 N/cm².

The product as proposed can thus be fixed on the surfaces of objects or elements using the adhesive tape 40, these objects or elements can then be assembled by means of the retaining elements 20 in a reliable and reversible manner.

The different dimensional characteristics indicated in this text are averages taken from three individual measurements.

Although the present invention has been described with reference to specific embodiments, it is evident that modifications and changes can be made to these examples without departing from the general scope of the invention as defined by the claims. In particular, individual features of the different illustrated/mentioned embodiments can be combined in additional embodiments. Therefore, the description and drawings should be considered in an illustrative rather than a restrictive sense.

It is also obvious that all the characteristics described with reference to a method can be transposed, alone or in combination, to a device, and conversely, all the characteristics described with reference to a device can be transposed, alone or in combination, to a method.

1. A retaining device comprising:
a base, comprising a woven material,
a plurality of retaining elements, said retaining elements each comprising a rod and a head,
the rod extending from an upper face of the base, and the head being formed at a free end of the rod opposite the upper face of the base,
the rods of the retaining elements extending at least partly in the woven material of the base,
wherein a portion of each of the rods extending from the base is at least partially coated with resin.

2. The retaining device according to claim 1, wherein at least 7% of the height of each rod is coated with resin, in particular 10% of the height of each rod, the height being measured in a direction perpendicular to the upper face of the base.

3. The retaining according to claim 2, wherein each retainer has a height greater than or equal to 0.5 mm, and the resin coating covers at least 0.1 mm of the height of each rod.

4. The retaining device according to claim 1, wherein the heads of the retaining elements have the shape of a portion of a sphere, extending from the free end of the rod, in particular a half-sphere portion, or have multilobed shapes, in particular with a number of lobes comprised between 2 and 10.

5. The device according to claim 1, wherein the rod has a circular or oval or square or rectangular section or in the general shape of a star with X regularly distributed arms, X being comprised between 3 and 10, each arm having a proximal end and a distal end, the proximal ends of each of the arms being contiguous and the distal ends of the arms are all spaced from each other at the same angle.

6. The device according to claim 1, wherein the resin coating is produced with an epoxy resin or a polyurethane resin, in particular an aliphatic polyurethane resin, more particularly with a polyester-based aliphatic polyurethane resin.

7. The device according to claim 1, wherein the resin coating is produced with a resin having a viscosity less than or equal to 1500 mPa·s.

8. The retaining device according to claim 1, wherein a lower face of the base, opposite the upper face of the base, is covered with an adhesive.

9. The retaining device according to claim 1, wherein the base is formed of woven monofilament and/or multifilament synthetic wires.

10. The device according to claim 9, wherein said synthetic wires are made of thermoplastic material.

11. The device according to claim 1, wherein the upper face of the base has a density of retaining elements greater than or equal to 15 retaining elements per cm².

12. The device according to claim 1, wherein the base is composed of warp threads and weft threads intertwined in a repeatable pattern, and in which the rods of the retaining elements are intertwined in said warp and weft threads, so that each retaining element rod is intertwined in the base so as to at least partially surround a warp thread and/or a weft thread of the base.

13. A retaining assembly which comprises a first retaining device according to claim 1, and a second retaining device comprising:
a base, and
a plurality of retaining elements, said retaining elements each comprising a rod and a head, the rod extending from an upper face of the base, and the head being formed at a free end of the rod opposite the upper face of the base.

14. The retaining assembly according to claim 1, wherein the second retaining element is a retaining element.

15. The retaining assembly according to claim 13, wherein the separation force of the two devices is at least greater than 10 N/cm² and/or has an engagement force of the two devices greater than 5 N/cm².
